(19) United States
(12) Patent Application Publication
(10) Pub. No.: US 2012/0070740 A1
(43) Pub. Date: Mar. 22, 2012

(54) NEGATIVE ELECTRODE FOR LITHIUM ION SECONDARY BATTERY AND LITHIUM ION SECONDARY BATTERY

(76) Inventors: Katsumi Kashiwagi, Nara (JP); Hideharu Takezawa, Nara (JP); Masaya Ugaji, Osaka (JP)

(21) Appl. No.: 13/322,002

(22) PCT Filed: Mar. 16, 2011
(86) PCT No.: PCT/JP2011/001550

§ 371 Date: Nov. 22, 2011

(30) Foreign Application Priority Data
May 21, 2010 (JP) 2010-117167

(51) Int. Cl. H01M 4/134

(52) U.S. Cl. 429/218.1; 429/209

(57) ABSTRACT

Disclosed is a negative electrode for a lithium ion secondary battery, the negative electrode including a negative electrode current collector with protrusions formed on a surface thereon, and columnar bodies being carried on the protrusions and comprising an alloy active material capable of absorbing and releasing lithium ions. The columnar bodies each have a multilayer structure in which a plurality of unit layers comprising the alloy active material are stacked sequentially on the surface of the protrusion, and the average layer thickness of the unit layer in a region within 20% of the thickness of the columnar body extending from the surface of the protrusion is smaller than that in a region within 80% of the thickness of the columnar body extending from the top of the columnar body.

### RELATED APPLICATIONS

This application is the U.S. National Phase under 35 U.S.C. §371 of International Application No. PCT/JP2011/001550, filed on Mar. 16, 2011, which in turn claims the benefit of Japanese Application No. 2010-117167, filed on May 21, 2010, the disclosures of which Applications are incorporated by reference herein.

### TECHNICAL FIELD

The present invention relates to a high capacity lithium ion secondary battery, and specifically relates to an improvement of a negative electrode including an alloy active material containing silicon or tin as a negative electrode active material.

### BACKGROUND ART

Lithium ion secondary batteries are light in weight and have a high electromotive force and a high energy density. For this reason, the demand therefor has been increasing, for use as driving power sources for various mobile electronic devices, such as mobile phones, digital still cameras, and notebook personal computers.

A lithium ion secondary battery (hereinafter sometimes simply referred to as a “battery”) includes a negative electrode including a negative electrode active material capable of absorbing and releasing lithium ions, a positive electrode including a positive electrode active material capable of absorbing and releasing lithium ions, and a separator separating these from each other, and a non-aqueous electrolyte. In recent years, the employment of a so-called alloy active material containing silicon (Si) or tin (Sb) as the negative electrode active material, in place of a conventional carbon material such as graphite, has been widely investigated. This is because an alloy active material can achieve higher capacity and higher output than a carbon material.

An alloy active material, because of its high capacity, expands greatly while the battery is charged, and contracts greatly while the battery is discharged. In the case where, for example, the alloy active material is Si, provided that Si absorbs lithium ions to the maximum extent to become Li_{4.4}Si, the volume thereof is increased as much as about 4 times. As such, in a battery using an alloy active material as the negative electrode, a large stress is generated at the interface between the alloy active material and the negative electrode current collector carrying the alloy active material, due to the expansion of the alloy active material during charging. The generated stress causes deformation, such as wrinkle and warpage, of the negative electrode current collector, or separation of the alloy active material from the negative electrode current collector. This may result in deterioration of the charge/discharge cycle characteristics of the battery.

In order to solve the above discussed problem, Patent Document 1 below discloses that: in forming an active material layer represented by SiOₓ where 0.05≦x≦0.3 on the current collector by vapor deposition, deposition of SiOₓ and interval of deposition are alternated in order to suppress the increase in temperature of the current collector, thereby to suppress the interdiffusion between silicon and the current collector such as a copper foil; and columnar particles are aggregated, thereby to form an islands-like structure that can reduce the stress generated due to expansion. It is further disclosed that by configuring as above, it is possible to obtain a negative electrode in which the interface is prevented from becoming brittle, and the separation of the active material from the negative electrode current collector is suppressed.

Another known method to solve the problem is forming a plurality of columnar bodies comprising an alloy active material on the surface of the negative electrode current collector. By forming an alloy active material in the form of columnar bodies, the stress generated due to expansion during charging is reduced to some extent because of the presence of gaps between the columnar bodies.

For example, Patent Document 2 below discloses a method in which, in a negative electrode including an alloy active material in the form of columnar bodies comprising SiOₓ, the columnar bodies are each provided with a SiOₓ layer where the value x is large, at a predetermined portion in its interior, thereby to adjust the change in shape of the columnar bodies during charging. When the value x in SiOₓ is large, the expansion and contraction are suppressed as compared to when the value x is small.

### RELATED ART DOCUMENT

### Patent Document

Patent Document 1: Japanese Laid-Open Patent Publication No. 2007-207663

Patent Document 2: Japanese Laid-Open Patent Publication No. 2008-192594

### SUMMARY OF THE INVENTION

### Problem to be Solved by the Invention

There has been, however, the following problem in providing a SiOₓ layer where the value x is large at a portion of each columnar body as disclosed in Patent Document 2. The SiOₓ layer where the value x is relatively large does not expand greatly but has a higher electric conduction resistance, as compared to the adjacent SiOₓ layers where the value x is relatively small, and consequently, the capacity of the columnar body as a whole is reduced. Therefore, if a large number of SiOₓ layers where the value x is large are provided in the columnar body, the capacity of the columnar body as a whole is further reduced.

The present invention intends to provide a lithium ion secondary battery including a negative electrode including an alloy active material as a negative electrode active material, in which, in the negative electrode with the alloy active material in the form of columnar bodies being formed on the surface of the current collector, the high capacity is maintained, and at the same time, the separation of the active material from the current collector caused by repeated charging and discharging is suppressed.

### Means for Solving the Problem

One aspect of the present invention is a negative electrode for a lithium ion secondary battery, the negative electrode comprising a negative electrode current collector with protrusions formed on a surface thereon, and columnar bodies being carried on the protrusions and comprising an alloy active material capable of absorbing and releasing lithium ions, wherein the columnar bodies each have a multilayer structure in which a plurality of unit layers comprising the alloy active material are stacked sequentially on a surface of each of the protrusions, and an average layer thickness of the unit layer in a region within 20% of the thickness of the columnar body extending from the surface of the protrusion is smaller than an average layer thickness of the unit layer in a region within remaining 80% of the thickness of the columnar body.

### Effect of the Invention

According to the present invention, it is possible to provide a lithium ion secondary battery including an alloy active material being in the form of columnar bodies formed on the surface of the current collector, in which the high capacity is maintained, and the separation of the active material from the current collector caused by repeated charging and discharging is suppressed, and thus having excellent cycle characteristics.

These and other objects, features, aspects, and advantages of the present invention will become more apparent from the following detailed description and the accompanying drawings.

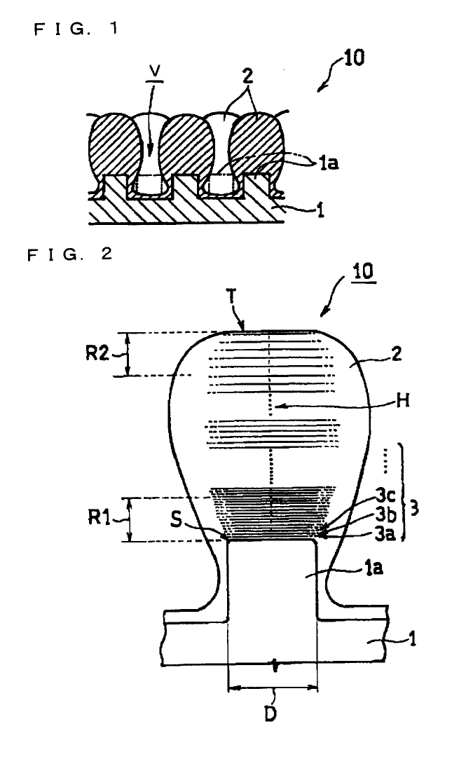

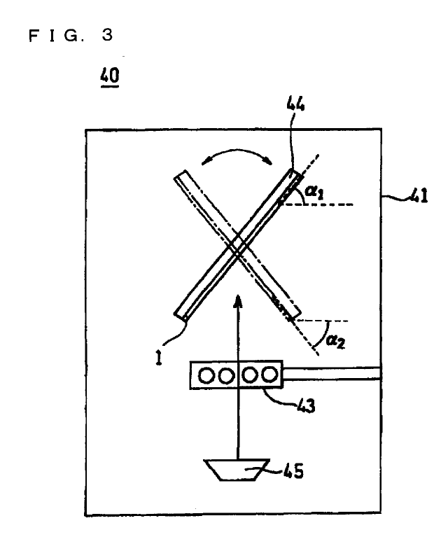

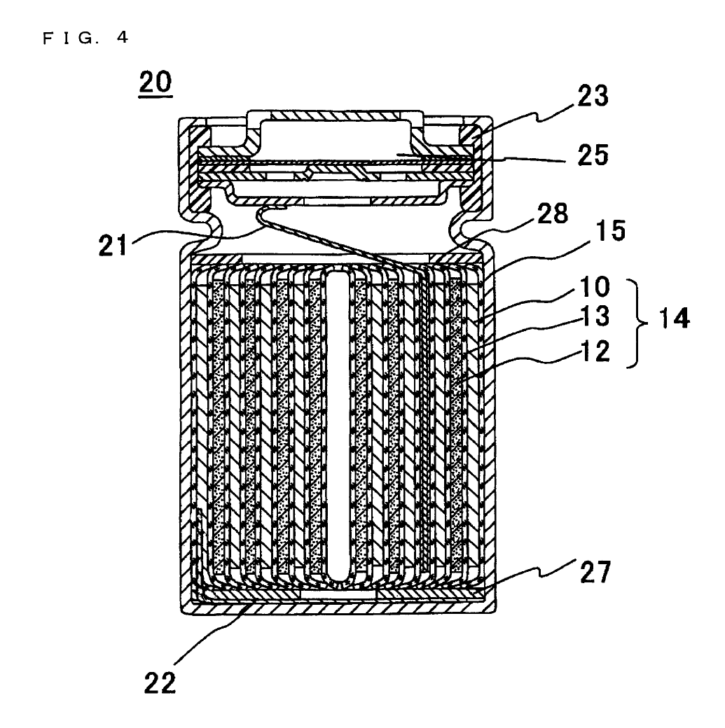

### BRIEF DESCRIPTION OF THE DRAWINGS

[FIG. 1] A schematic cross-sectional view schematically showing the structure of a negative electrode 10 of an embodiment of the present invention.

[FIG. 2] An enlarged schematic diagram of a columnar body 2 formed in the negative electrode 10.

[FIG. 3] A view schematically explaining one example of an apparatus for producing the negative electrode 10.

[FIG. 4] A cross-sectional schematic view showing a non-aqueous electrolyte secondary battery 20 of an embodiment of the present invention.

### BEST MODE FOR CARRYING OUT THE INVENTION

One embodiment of a lithium ion secondary battery of the present invention is described below with reference to the accompanying drawings.

FIG. 1 is a schematic cross-sectional view schematically showing the structure of a negative electrode 10 of this embodiment. FIG. 2 is an enlarged schematic diagram of a columnar body 2 formed in the negative electrode 10. In FIGS. 1 and 2, reference numeral 1 represents a negative electrode current collector with protrusions 1a formed on its surface, reference numeral 2 represents a columnar body being carried on the protrusion 1a and comprising an alloy active material capable of absorbing and releasing lithium ions, and reference letter V represents a gap between the columnar bodies 2.

As shown in FIG. 1, in the negative electrode 10, the columnar bodies 2 comprising a negative electrode active material are formed on the negative electrode current collector 1 having the protrusions 1a on its surface. The gap V is formed between the columnar bodies 2. The volumetric capacity of the gap V varies depending on the volume of the columnar bodies 2 that increases as the columnar bodies 2 expand in association with absorbing lithium ions.

As shown in FIG. 2, the columnar body 2 has a multilayer structure in which a plurality of unit layers 3 (3a, 3b, 3c . . . ) comprising an alloy active material are stacked sequentially on the surface of the protrusion 1a. The columnar body 2 is formed such that, provided that the thicknesses of the unit layers 3 are measured along the straight-line segment (H) connecting from the surface (S) of the protrusion 1a to the center of the top (T) of the columnar body 2, the average layer thickness per one layer of the unit layers 3 in the region (R1) within 20% of the thickness of the columnar body extending from the surface of the protrusion 1a is smaller than the average layer thickness per one layer of the remaining unit layers 3 in the region within 80% of the thickness of the columnar body extending from the top the columnar body 2 (i.e., the region except R1). It should be noted that in the columnar body 2, the average layer thickness per one layer of the unit layers 3 gradually increases with distance away from the surface of the protrusion 1a. Although the unit layers are formed such that the thickness of each layer gradually increases with distance away from the surface of the protrusion 1a in this embodiment, the present invention is not limited to such embodiment. Specifically, for example, the 20% thickness region extending from the surface of the protrusion may be composed of the unit layers having the same thickness, and the remaining 80% thickness region may be composed of the unit layers which have the same thickness and are thicker than those in the 20% thickness region extending from the surface of the protrusion.

Each of the unit layers 3 (3a, 3b, 3c . . . ) comprises an alloy active material. Examples of the alloy active material include silicon, tin, a silicon oxide, a tin oxide, a silicon alloy, or a tin alloy. The silicon oxide is represented by, for example, SiOₓ where 0<x<1.99. The tin oxide is represented by, for example, SnO_{y} where 0<y<2.

As the alloy active material, silicon or a silicon oxide is particularly preferred because it has a high reaction efficiency and a high capacity and is comparatively inexpensive. In particular, a silicon oxide whose average composition is represented by SiOₓ where preferably 0≦x<0.7 and more preferably 0.1≦x<0.4 is preferred for its high capacity, excellent adhesion with the current collector, and high capacity retention rate after repeated charging and discharging.

It is preferable that the alloy active material forming the unit layers 3 has a substantially constant composition, because this can maintain the conduction resistance around the interface with the current collector constant and reduce the variations in reaction, and thus can provide a good balance between the capacity and the adhesion of the columnar bodies.

In the portion near the surface of the protrusion 1a in the columnar body 2, in which the thickness per one layer of the unit layers 3 is smaller than that in the portion away from the surface, the number of interfaces between layers per unit length is increased. As such, in the portion near the surface of the protrusion 1a, the conduction resistance per unit length is increased, and thus the reactivity is lowered, which suppresses the expansion and contraction during charging and discharging. As a result, the excellent adhesion with the surface of the protrusion 1a can be maintained.

On the other hand, in the portion away from the surface of the protrusion 1a of the columnar body 2, in which the thickness per one layer of the unit layers 3 is larger than that in the portion near the surface, the number of interfaces between layers per unit length is decreased. As such, in the portion away from the surface of the protrusion 1a, the conduction resistance per unit length is decreased, and thus the reactivity is enhanced. As a result, the high reactivity can be maintained in the portion away from the surface of the protrusion 1a.

The average thickness of the unit layer 3 in the 20% thickness region (R1) extending from the surface (S) of the protrusion 1a is preferably 40 to 500 nm, and more preferably 50 to 200 nm. When the average thickness in this portion is within this range, the reactivity in this region is suitably lowered, and the expansion and contraction are suppressed, which makes it possible to maintain excellent adhesion with the surface of the protrusion la.

Similarly, provided that the thicknesses of the unit layers 3 are measured along the straight-line segment (H) connecting from the surface (S) of the protrusion 1a to the center of the top (T) of the columnar body 2, the average thickness of the unit layer 3 in the 20% thickness region (R2) extending from the top (T) of the columnar body 2 is preferably 100 to 2000 nm, more preferably 200 to 1000 nm, and particularly preferably 200 to 500 nm. When the average thickness in this portion is within this range, the high reactivity in this region can be maintained.

It is more preferable to combine the average layer thickness of the unit layer 3 in the 20% thickness region (R1) extending from the surface (S) of the protrusion 1a of 50 to 200 nm and the average layer thickness of the unit layer 3 in the remaining 80% thickness region of 200 to 500 nm.

The average thickness of the unit layer in the 80% thickness region extending from the top (T) of the columnar body 2 is preferably 1.5 to 10 times and more preferably 1.5 to 5 times as large as the average layer thickness of the unit layer in the 20% thickness region (R1) extending from the surface of the protrusion 1a, because this can provide a better balance between the capacity and the adhesion.

The average thickness of the unit layer in the 20% thickness region (R2) extending from the top (T) of the columnar body 2 is preferably 2 to 20 times and more preferably 2 to 10 times as large as the average layer thickness of the unit layer in the 20% thickness region (R1) extending from the surface of the protrusion 1a, because this can provide a better balance between the capacity and the adhesion. The total number of the unit layers in the 20% thickness region (R1) extending from the surface (S) of the protrusion 1a is preferably 1.5 to 20 times and more preferably 2 to 10 times as large as the total number of the unit layers in the 20% thickness region (R2) extending from the top (T) of the columnar body 2.

The height of the columnar body 2 measured from the surface (S) of the protrusion 1a to the top (T) of the columnar body 2 is preferably 5 to 30 μm and more preferably 8 to 20 μm.

The total number of the unit layers 3 in the columnar body 2 is preferably 5 to 100 layers, more preferably 15 to 90 layers, and particularly preferably 50 to 85 layers, because this can provide a good balance between the capacity and the adhesion of the columnar bodies.

The material of the negative electrode current collector 1 is not particularly limited and may be, for example, copper, or a copper alloy.

Next, the method of producing the negative electrode 10 according to this embodiment is specifically described with reference to FIG. 3.

The columnar bodies 2 are formed by obliquely vapor-depositing a vapor deposition source, such as silicon, tin, a silicon oxide, or a tin oxide on the surface of the negative electrode current collector 1 having the protrusions 1a, using an electron beam vapor deposition apparatus 40 as shown in FIG. 3. Specifically, first, the negative electrode current collector 1 is fixed on a support table 44 in the vapor deposition apparatus 40. A vapor deposition source 45, such as silicon, tin, a silicon oxide, or a tin oxide is set. The angle α₁ between the surface of the support table 44 and the horizontal direction is adjusted. The angle α₁ is preferably to about 50 to 72° and more preferably to about 60 to 65°, because the smooth surface area free of protrusions 1a on the negative electrode current collector 1 is shadowed by the protrusions 1a in the oblique vapor deposition, and thus the alloy active material is prevented from excessively adhering to the smooth surface area.

Thereafter, gas is ejected from a nozzle 43 at a predetermined flow rate. An inert gas, such as argon or helium is used as the gas. The gas to be supplied for adjusting the oxygen content in the alloy active material may contain a small amount of oxygen, if necessary. The pressure in a vacuum chamber 41 is adjusted using an exhaust pump (not shown). The accelerating voltage of electron beams is adjusted, and then vapor deposition is performed for a predetermined length of time. The 1st layer is vapor-deposited in such a process.

After the vapor deposition of the 1st layer, the support table 44 is swung, so that the angle between the surface of the support table 44 and the horizontal direction is adjusted to α₂. The angle α₂ is usually adjusted to an angle similar to the angle α₁ in the opposite side with respect to the direction normal to the protrusions 1a. The 2nd layer is vapor-deposited under the same conditions as those for the vapor deposition of the 1st layer.

The vapor deposition of a raw material component is repeated the number of times corresponding to the number of layers to be formed, with the support table 44 being set at the angle α₁ and the angle α₂ alternately, to form the columnar bodies 2 supported on the protrusions 1a on the surface of the negative electrode current collector 1. The negative electrode 10 is thus obtained.

In order to forming layers such that the thickness per one layer of the unit layers 3 increases with distance away from the surface of the protrusion 1a, the length of vapor deposition time for each layer must be increased gradually so that the thickness of each layer can be controlled as intended. By adjusting the length of vapor deposition time as above, the columnar bodies 2 in each of which the thickness of each layer gradually increases with distance away from the surface of the protrusion 1a can be obtained.

Next, a cylindrical lithium ion secondary battery 20 of this embodiment is described with reference to the schematic cross-sectional view in FIG. 4.

The lithium ion secondary battery 20 includes: an electrode group 14 including a belt-like negative electrode 10, a belt-like positive electrode 12, a belt-like separator 13 separating the negative electrode 10 from the positive electrode 12, which are wound together; and a non-aqueous electrolyte with lithium ion conductivity (now shown).

The lithium ion secondary battery 20 shown in FIG. 4 is formed by sealing the electrode group 14 and the non-aqueous electrolyte (not shown) in a battery case 15. The electrode group 14 is formed by winding the positive electrode 12 and the negative electrode 10 with the separator 13 interposed therebetween. A positive electrode lead 21 is extended from the positive electrode 12 and is connected to a sealing plate 25, and a negative electrode lead 22 is extended from the negative electrode 10 and is connected to the bottom of the battery case 15. On the top and bottom of the electrode group, insulating rings 27 and 28 are provided, respectively. After injection of the non-aqueous electrolyte, the battery case 15 is sealed with a sealing plate 25 via a gasket 23.

Examples of the battery case include an aluminum case, an iron case with the inner surface plated with nickel, or a case made of aluminum laminate film. The battery case may be of any shape, such as cylindrical and prismatic.

The positive electrode 12 is obtained by, for example, dispersing a positive electrode active material and, if necessary, various conductive agents and binders in an appropriate dispersion medium to prepare a positive electrode material mixture, applying the positive electrode material mixture on a surface of the positive electrode current collector, and drying it to form a positive electrode active material layer 19.

Examples of the positive electrode active material include composite oxides, such as lithium cobalt oxides, and modified forms thereof (e.g., a solid solution of a lithium cobalt oxide and aluminum or magnesium); lithium nickel oxides and modified forms thereof (e.g., a lithium nickel oxide in which nickel is partially substituted by cobalt); and lithium manganese oxides and modified forms thereof.

Examples of the conductive agent include: carbon blacks, such as acetylene black, Ketjen black, channel black, furnace black, lamp black, and thermal black; and various graphites. Examples of the binder include polyvinylidene fluoride, polytetrafluoroethylene, and a particulate rubber having an acrylate unit. These may be used singly or in combination of two or more.

The separator 13, the non-aqueous electrolyte, the battery case 15, and the gasket 22 are not particularly limited, and may be made of any material known in the art.

The separator 13 is arranged between the positive electrode 12 and the negative electrode 10, and may be made of, for example, a porous sheet of polyolefin such as polyethylene or polypropylene. The thickness of the separator 13 is not particularly limited, but is preferably about 10 to 300 μm, and more preferably about 10 to 40 μm.

The non-aqueous electrolyte contains a solute (a supporting salt) and a non-aqueous solvent, and further contains various additives, if necessary. The solute is usually dissolved in the non-aqueous solvent.

Examples of the non-aqueous solvent include: cyclic carbonic acid esters, such as propylene carbonate and ethylene carbonate; chain carbonic acid esters, such as diethyl carbonate, ethyl methyl carbonate, and dimethyl carbonate; and cyclic carboxylic acid esters, such as γ-butyrolactone and γ-valerolactone. These may be used singly or in combination of two or more.

Examples of the solute include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, LiBCl₄, borates, and imides. These may be used singly or in combination of two or more. The solute is preferably dissolved in an amount of about 0.5 to 2 mol per liter of the non-aqueous solvent.

The lithium ion secondary battery 20 as above is fabricated in the manner similar to a conventionally known manner for fabricating a lithium ion secondary battery.

Although the lithium ion secondary battery 20, which is a cylindrical battery including a wound electrode group, is specifically described in this embodiment as a typical example, the lithium ion secondary battery of the present invention is not limited thereto and may be, for example, a coin battery including a laminated electrode group, a prismatic battery including a flat electrode group, or a laminate film battery including a laminated electrode group or flat electrode group.

### EXAMPLES

The present invention is more specifically described below by way of examples. The following examples, however, should not be construed as limiting the scope of the invention.

### Example 1

<Production of Negative Electrode>

A copper alloy foil on both surfaces of which a plurality of protrusions are formed in a staggered pattern (i.e., a two-dimensional triangular lattice pattern) was used as the negative electrode current collector. The protrusions are each of a cylindrical shape having a diameter of 8 μm and a height of 8 μm.

Next, an alloy active material was vapor-deposited on both surfaces of the negative electrode current collector to form columnar bodies, using the vapor deposition apparatus 40 as shown in FIG. 3, thereby to produce a negative electrode. The vapor deposition source 45 was silicon with purity of 99.99990, and the gas ejected from the nozzle 43 was a mixed gas of oxygen and argon.

In forming the columnar bodies, first, the negative electrode current collector was placed on the fixing table 44 in the vapor deposition apparatus 40, the angle α₁ between the surface of the support table 44 and the horizontal direction was adjusted to 60°. Prior to vapor deposition, the vacuum chamber 41 was evacuated by an exhaust pump to 7×10³ Pa (abs). Subsequently, the mixed gas was supplied from the nozzle 43 into the vacuum chamber 41 at a flow rate of 20 sccm. Then, vapor deposition of the 1st layer was carried out with the accelerating voltage of electron beams set to −8 kv and the emission set to 500 mA.

Next, the angle α₂ between the surface of the support table 44 in the vapor deposition apparatus 40 and the horizontal direction was adjusted to 60°, and vapor deposition of the 2nd layer was carried out in the same manner as in the vapor deposition of the 1st layer. Vapor deposition was repeated to form the 3rd to 82th layers. Through the vapor deposition of the 1st to 82th layers, the length of vapor deposition time of each layer was increased, so that the father a layer to be formed was away from the surface of the protrusion, the larger the thickness of the layer was. In such a manner, a 15-μm-high columnar body whose average composition and composition of each layer was represented by SiO_{0.25} was formed.

The columnar body thus formed had a multilayer structure including 82 layers in total, in which the average thickness of the unit layer in the 1st to 30th layers corresponding to the 20% thickness region extending from the surface of the protrusion was 100 nm. The average thickness of the unit layer in the 76th to 82th layers corresponding to the 20% thickness region extending from the top of the columnar body was 430 nm. The average thickness of the unit layer in the 31th to 75th layers corresponding to the remaining central 60% thickness region was 200 nm. The negative electrode thus obtained was cut in the size of 32 mm×420 mm, to produce a belt-like negative electrode plate.

<Production of Positive Electrode>

First, 93 g of lithium-nickel-containing composite oxide powder having a composition represented by LiNi_{0.85}Co_{0.15}O₂ (the average particle diameter of secondary particles: 10 μm) was mixed with 3 g of acetylene black (a conductive agent), 4 g of polyvinylidene fluoride powder (a binder), and 50 mL of N-methyl-2-pyrrolidone (NMP), to prepare a positive electrode material mixture slurry. The positive electrode material mixture slurry was applied onto both surfaces of a 15-μm-thick aluminum foil (a positive electrode current collector), dried and rolled, to form a positive electrode active material layer having a thickness of 120 μm. The positive electrode thus obtained was cut in the size of 30 mm×380 mm, to produce a belt-like positive electrode plate.

<Production of Lithium Ion Secondary Battery>

The belt-like positive and negative electrode plates produced in the above were wound with a belt-like separator (a 35 mm×1000 mm polyethylene microporous film, trade name: Hipore, thickness: 20 μm, available from Asahi Kasei Corporation) interposed therebetween, to form an electrode group. Next, one end of a positive electrode lead made of aluminum was welded to the positive electrode current collector in the belt-like positive electrode plate, and one end of a negative electrode lead made of nickel was welded to the negative electrode current collector in the belt-like negative electrode plate.

The electrode group thus formed was inserted together with a non-aqueous electrolyte into an outer case made of aluminum laminate sheet. The non-aqueous electrolyte was prepared by dissolving LiPF₆ at a concentration of 1.4 mol/L in a mixed solvent containing ethylene carbonate, ethyl methyl carbonate and diethyl carbonate at a ratio of 2:3:5 by volume. Next, the positive and negative electrode leads were drawn outward from the opening of the outer case, and the opening of the outer case was fused while the internal pressure thereof was reduced to near vacuum. A lithium ion secondary battery A was thus produced.

<Evaluation of Lithium Ion Secondary Battery>

The produced lithium ion secondary battery A was evaluated for the battery capacity, the capacity retention rate after 100 charge/discharge cycles, and the peel strength of the negative electrode active material, in the manner as described below.

[Battery Capacity]

The produced lithium ion secondary battery A was subjected to 3 charge/discharge cycles under the conditions below, to determine the discharge capacity at the 3rd cycle.

Constant-current charge: 0.7 C, cut-off voltage 4.15 V

Constant-voltage charge: 4.15V 0.05 C, interval between charge and discharge 20 min

Constant-current discharge: 0.2 C, cut-off voltage 2.0 V, interval between discharge and charge 20 min

[Capacity Retention Rate After 100 Charge/Discharge Cycles]

The produced lithium ion secondary battery A was subjected to 100 charge/discharge cycles each consisting of constant-current charge, constant-voltage charge and constant-current discharge, under the conditions above. The discharge capacity at the 1st cycle was defined as an “initial discharge capacity”, and the current value at this discharge was defined as “1C”. The percentage of the discharge capacity after 100 cycles to the initial discharge capacity was determined as a capacity retention rate (%).

[Peel Strength of Negative Electrode Active Material]

The battery having been subjected to 100 charge/discharge cycles and being in a discharged state was disassembled, from which the negative electrode was taken out. The taken out negative electrode was washed with ethyl methyl carbonate and used as a sample. One surface of the sample was bonded to a flat table and fixed. Subsequently, on the surface of the alloy active material in the sample, an adhesive tape (available from Nitto Denko Corporation) was placed. The adhesive tape was placed such that its adhesive surface contacted the surface of the alloy active material in the sample, and was pushed with a 02-mm flat terminal onto the sample, with a force of 400 gf (approx. 3.92 N) applied thereto. Thereafter, the flat terminal was pulled up vertically, to measure a stress at the time of peeling of the columnar bodies (the negative electrode active material 2) from the protrusions 1a of the negative electrode current collector 1.

The results of the above evaluation are shown in Table 1 below.

TABLE 1

| | | | Example No. | | | | | | | | |
|---|---|---|---|---|---|---|---|---|---|---|---|
| | | | | | | | | | Com. | Com. | Com. |
| | | | 1 | 2 | 3 | 4 | 5 | 6 | Ex. 1 | Ex. 2 | Ex. 3 |
| Characteristics | (A) | nm | 100 | 100 | 100 | 150 | 100 | 100 | 200 | 100 | 300 |
| of columnar | | Number of | 30 | 30 | 30 | 20 | 28 | 30 | 15 | 30 | 10 |
| bodies | | layers | | | | | | | | | |
| | | Composition | SiO_{0.25} | SiO_{0.4} | SiO_{0.7} | SiO_{0.25} | SiO_{0.1} | SiO_{0.25} | SiO_{0.25} | SiO_{0.25} | SiO_{0.25} |
| | (B) | nm | 200 | 200 | 200 | 250 | 200 | 300 | 200 | 100 | 300 |
| | | Number of | 45 | 45 | 45 | 36 | 42 | 30 | 45 | 90 | 30 |
| | | layers | | | | | | | | | |
| | | Composition | SiO_{0.25} | SiO_{0.4} | SiO_{0.15} | SiO_{0.25} | SiO_{0.1} | SiO_{0.25} | SiO_{0.25} | SiO_{0.25} | SiO_{0.25} |
| | (C) | nm | 430 | 420 | 400 | 430 | 400 | 300 | 200 | 100 | 300 |
| | | Number of | 7 | 7 | 7 | 7 | 7 | 20 | 15 | 30 | 10 |
| | | layers | | | | | | | | | |
| | | Composition | SiO_{0.25} | SiO_{0.4} | SiO_{0.15} | SiO_{0.25} | SiO_{0.1} | SiO_{0.25} | SiO_{0.25} | SiO_{0.25} | SiO_{0.25} |
| | (D) | μm | 15 | 15 | 15 | 15 | 14 | 15 | 15 | 15 | 15 |
| | (E) | Composition | SiO_{0.25} | SiO_{0.4} | SiO_{0.26} | SiO_{0.25} | SiO_{0.1} | SiO_{0.25} | SiO_{0.25} | SiO_{0.25} | SiO_{0.25} |
| Evaluation | (F) | mAh | 338 | 315 | 338 | 335 | 350 | 336 | 338 | 336 | 338 |
| results | (G) | % | 91 | 93 | 90 | 89 | 86 | 89 | 75 | 81 | 69 |
| | (H) | MPa | 2.2 | 2.3 | 2.1 | 2.0 | 2.1 | 2.1 | 1.4 | 1.5 | 1.1 |

(A) The average thickness, the number of layers, and the average composition in the 20% region extending from the surface of the protrusion
(B) The average thickness, the number of layers, and the average composition in the central 60% region
(C) The average thickness, the number of layers, and the average composition in the 20% region extending from the top of the columnar body
(D) The height of the columnar body
(E) The average composition of the columnar body
(F) The capacity of the battery
(G) The capacity retention rate after 100 cycles
(H) The peel strength of the negative electrode active material

### Example 2

A negative electrode B was produced in the same manner as in Example 1, except that in “Production of negative electrode”, unit layers each having a composition represented by SiO_{0.4} were formed instead of the unit layers each having a composition represented by SiO_{0.25}, and the average thickness of the unit layer in the 76th to 82th layers corresponding to the 20% thickness region extending from the top of the columnar body was changed to 420 nm, as shown in Table 1. A lithium ion secondary battery B was produced and evaluated in the same manner as in Example 1, except that the negative electrode B was used in place of the negative electrode A. The results are shown in Table 1.

### Example 3

A negative electrode C was produced in the same manner as in Example 1, except that in “Production of negative electrode”, in the multilayer structure including 82 layers in total, the average composition of the unit layer in the 1st to 30th layers corresponding to the 20% thickness region extending from the surface of the protrusion was changed to SiO_{0.7}, the average composition of the unit layer in the 31th to 75th layers corresponding to the central 60% thickness region was changed to SiO_{0.15}, and the average thickness and composition of the unit layer in the 76th to 82th layers corresponding to the 20% thickness region extending from the top of the columnar body were changed to 400 nm and SiO_{0.15}, respectively, as shown in Table 1. A lithium ion secondary battery C was produced and evaluated in the same manner as in Example 1, except that the negative electrode C was used in place of the negative electrode A. The results are shown in Table 1.

### Example 4

A negative electrode D was produced in the same manner as in Example 1, except that in “Production of negative electrode”, columnar bodies each having a multilayer structure including 63 layers in total was formed, in which the average thickness of the unit layer in the 1st to 20th layers corresponding to the 20% thickness region extending from the surface of the protrusion was 150 nm, the average thickness of the unit layer in the 57th to 63th layers corresponding to the 20% thickness region extending from the top of the columnar body was 430 nm, and the average thickness of the unit layer in the 21th to 56th layers corresponding to the remaining central 60% thickness region was 250 nm, as shown in Table 1. A lithium ion secondary battery D was produced and evaluated in the same manner as in Example 1, except that the negative electrode D was used in place of the negative electrode A. The results are shown in Table 1.

### Example 5

A negative electrode E was produced in the same manner as in Example 1, except that in “Production of negative electrode”, unit layers each having a composition represented by SiO_{0.1} was formed instead of the unit layers each having a composition represented by SiO_{0.25}, and columnar bodies each having a multilayer structure including 77 layers in total were formed, in which the average thickness of the unit layer in the 1st to 28th layers corresponding to the 20% thickness region extending from the surface of the protrusion was 100 nm, the average thickness of the unit layer in the 71th to 77th layers corresponding to the 20% thickness region extending from the top of the columnar body was 400 nm, and the average thickness of the unit layer in the 29th to 70th layers corresponding to the remaining central 60% thickness region was 200 nm, as shown in Table 1. A lithium ion secondary battery E was produced and evaluated in the same manner as in Example 1, except that the negative electrode E was used in place of the negative electrode A. The results are shown in Table 1.

### Example 6

A negative electrode F was produced in the same manner as in Example 1, except that in “Production of negative electrode”, columnar bodies each having a multilayer structure including 80 layers in total were formed, in which the average thickness of the unit layer in the 1st to 30th layers corresponding to the 20% thickness region extending from the surface of the protrusion was 100 nm, and the average thickness of the unit layer in the 31th to 80th layers corresponding to the remaining 80% thickness region in the columnar body was 300 nm, as shown in Table 1. A lithium ion secondary battery F was produced and evaluated in the same manner as in Example 1, except that the negative electrode F was used in place of the negative electrode A. The results are shown in Table 1.

### Comparative Example 1

A negative electrode G was produced in the same manner as in Example 1, except that in “Production of negative electrode”, 15-μm-high columnar bodies each having a multilayer structure including 75 layers in total, each of the layers having a composition represented by SiO_{0.25} and an average thickness of 200 nm, were formed, by equalizing the vapor deposition time of each layer from the 1st to 75th layers. A lithium ion secondary battery G was produced and evaluated in the same manner as in Example 1, except that the negative electrode G was used in place of the negative electrode A. The results are shown in Table 1.

### Comparative Example 2

A negative electrode H was produced in the same manner as in Example 1, except that in “Production of negative electrode”, 15-μm-high columnar bodies each having a multilayer structure including 150 layers in total, each of the layers having a composition represented by SiO_{0.25} and an average thickness of 100 nm, were formed, by equalizing the vapor deposition time of each layer from the 1st to 150th layers. A lithium ion secondary battery H was produced and evaluated in the same manner as in Example 1, except that the negative electrode H was used in place of the negative electrode A. The results are shown in Table 1.

### Comparative Example 3

A negative electrode I was produced in the same manner as in Example 1, except that in “Production of negative electrode”, 15-μm-high columnar bodies each having a multilayer structure including 50 layers in total, each of the layers having a composition represented by SiO_{0.25} and an average thickness of 300 nm, were formed, by equalizing the vapor deposition time of each layer from the 1st to 50th layers. A lithium ion secondary battery I was produced and evaluated in the same manner as in Example 1, except that the negative electrode I was used in place of the negative electrode A. The results are shown in Table 1.

Table 1 shows that the lithium ion secondary batteries A to F of Examples 1 to 5 according to the present invention, in which in the columnar body comprising an alloy active material formed in the negative electrode, the average layer thickness of the unit layer in the 20% thickness region extending from the surface of the protrusion was smaller than that in the remaining 80% thickness region, exhibited higher values of both the capacity retention rate after 100 cycles and the peel strength of the negative electrode active material, as compared to the lithium ion secondary batteries G to I of Comparative Examples 1 to 3, in which each layer had the same thickness. Compared with Example 2 including columnar bodies having an average composition represented by SiO_{0.4}, Example 1 including columnar bodies having an average composition represented by SiO_{0.25} had a higher capacity. Compared with Example 3 including columnar bodies whose average composition is similar to those in Example 1, Example 1 in which all the layers forming the columnar body had the same composition was more excellent in the capacity retention rate after 100 cycles and the peel strength of the negative electrode active material. Example 4, in which in the columnar body, the unit layers in the 20% thickness region extending from the surface of the protrusion were thick, was slightly inferior to Example 1, in terms of the capacity retention rate after 100 cycles and the peel strength of the negative electrode active material.

One aspect of the present invention described in detail above is a negative electrode for a lithium ion secondary battery, the negative electrode including a negative electrode current collector with protrusions formed on its surface, and columnar bodies being carried on the protrusions and comprising an alloy active material capable of absorbing and releasing lithium ions, wherein the columnar bodies each have a multilayer structure in which a plurality of unit layers comprising the alloy active material are stacked sequentially on the surface of the protrusion, and the average layer thickness of the unit layer in the 20% thickness region extending from the surface of the protrusion is smaller than that in the remaining 80% thickness region. According to such a configuration, the number of interfaces between unit layers is increased in the portion near the surface of the protrusion in the columnar body, and the number of interfaces between unit layers is decreased in the portion away from the surface of the protrusion in the columnar body. The conduction resistance is high at the interfaces between unit layers. Therefore, in the portion required to be excellent in adhesion near the surface of the protrusion, the reactivity is lowered, and the expansion and contraction during charging and discharging are suppressed. On the other hand, in the portion which is away from the surface of the protrusion and in which the number of interfaces between unit layers is decreased, the high reactivity can be maintained. As a result, the high capacity of the columnar bodies as a whole can be maintained, while the excellent adhesion thereof can be maintained.

It is preferable that the average layer thickness of the unit layer in the 20% thickness region extending from the surface of the protrusion is 50 to 200 nm, and the average layer thickness of the unit layer in the remaining 80% thickness region is 200 to 500 nm, because this provides a good balance between the capacity and the adhesion of the columnar bodies.

The average layer thickness of the unit layer in the remaining 80% thickness region is preferably 1.5 to 5 times as large as the average layer thickness of the unit layer in the 20% thickness region extending from the surface of the protrusion, because this can provide a better balance between the capacity and the adhesion of the columnar bodies.

The total number of the unit layers in the 20% thickness region extending from the surface of the protrusion is preferably 1.5 to 20 times as large as the total number of the unit layers in the 20% thickness region extending from the top of the columnar body, because this can provide a better balance between the capacity and the adhesion of the columnar bodies.

It is preferable that the alloy active material forming the unit layers has a substantially constant composition, because this can provide a good balance between the high capacity and the adhesion of the columnar bodies.

The alloy active material of the columnar body is preferably has a composition represented by SiOₓ where 0≦x<0.4, because this can maintain a higher capacity.

Another aspect of the present invention is a lithium ion secondary battery including a positive electrode capable of absorbing and releasing lithium ions, a negative electrode capable of absorbing and releasing lithium ions, a separator interposed between the positive electrode and the negative electrode, and a non-aqueous electrolyte, wherein the negative electrode is the above-described negative electrode. According to such a configuration, it is possible to provide a lithium ion secondary battery in which the high capacity is maintained, and at the same time, the separation of the active material from the current collector caused by repeated charging and discharging is suppressed.

### INDUSTRIAL APPLICABILITY

In a lithium ion secondary battery including the negative electrode of the present invention, the high charge/discharge capacity characteristic of an alloy active material is maintained, and at the same time, the separation of the active material from the current collector caused by repeated charging and discharging is suppressed. Therefore, it can be preferably used as a power source required to have a high capacity and a long life, such as a driving power source for electronic equipment or a power source for hybrid vehicles or electric vehicles.

### REFERENCE SIGNS LIST

1 Negative electrode current collector

1a Protrusion

2 Columnar body

3 (3a, 3b, 3c . . . ) Unit layer

10 Negative electrode

11 Non-aqueous electrolyte secondary battery

12 Positive electrode

13 Separator

14 Electrode group

15 Battery case

22 Negative electrode lead

21 Positive electrode lead

23 Gasket

25 Sealing plate

27, 28 Insulating ring

40 Electron beam vapor deposition apparatus

41 Chamber

42 Piping

43 Nozzle

44 Support table

45 Target

1. A negative electrode for a lithium ion secondary battery, the negative electrode comprising a negative electrode current collector with protrusions formed on a surface thereon, and columnar bodies being carried on the protrusions and comprising an alloy active material capable of absorbing and releasing lithium ions, wherein
the columnar bodies each have a multilayer structure in which a plurality of unit layers comprising the alloy active material are stacked sequentially on a surface of each of the protrusions, and
an average layer thickness of the unit layer in a region within 20% of a thickness of the columnar body extending from the surface of the protrusion is smaller than an average layer thickness of the unit layer in a region within remaining 80% of the thickness of the columnar body.

2. The negative electrode for a lithium ion secondary battery in accordance with claim 1, wherein the average layer thickness of the unit layer in the region within 20% of the thickness of the columnar body extending from the surface of the protrusion is 50 to 200 nm, and the average layer thickness of the unit layer in the region within remaining 80% of the thickness of the columnar body is 200 to 500 nm.

3. The negative electrode for a lithium ion secondary battery in accordance with claim 1, wherein the average layer thickness of the unit layer in the region within remaining 80% of the thickness of the columnar body is 1.5 to 5 times as large as the average layer thickness of the unit layer in the region within 20% of the thickness of the columnar body extending from the surface of the protrusion.

4. The negative electrode for a lithium ion secondary battery in accordance with claim 1, wherein a total number of the unit layers in the region within 20% of the thickness of the columnar body extending from the surface of the protrusion is 1.5 to 20 times as large as a total number of the unit layers in a region within 20% of the thickness of the columnar body extending from a top of the columnar body.

5. The negative electrode for a lithium ion secondary battery in accordance with claim 1, wherein the alloy active material forming the plurality of unit layers has a constant composition.

6. The negative electrode for a lithium ion secondary battery in accordance with claim 1, wherein an average composition of the alloy active material in the columnar body is represented by SiOₓ where 0≦x<0.4.

7. A lithium ion secondary battery comprising a positive electrode capable of absorbing and releasing lithium ions, a negative electrode capable of absorbing and releasing lithium ions, a separator interposed between the positive electrode and the negative electrode, and a non-aqueous electrolyte, wherein
the negative electrode is the negative electrode of claim 1.
